(19) United States
(12) Patent Application Publication
(10) Pub. No.: US 2005/0182677 A1
(43) Pub. Date: Aug. 18, 2005

(54) Method and/or system for providing web-based content

(76) Inventor: Christopher M. Hill, Baton Rouge, LA (US)

Correspondence Address: Berkeley Law and Technology Group, 680 NW Altishin Place, Beaverton, OR, 97006, US

(21) Appl. No.: 10/782,586

(22) Filed: Feb. 18, 2004

(51) Int. Cl. G06F 17/60

(52) U.S. Cl. 705/14

(57) ABSTRACT

Embodiments of methods, apparatuses, devices, and/or systems for providing web based content are described.

### BACKGROUND

The Internet is comprised of a multitude of interconnected or coupled devices, such as computing devices, interconnected or coupled to form a distributed database of electronic data, from one perspective. Devices which may be coupled to the Internet may be referred to as internet-capable devices, and may be capable of exchanging electronic data with one or more other devices connected or coupled to the Internet, for example. One particular interface for navigating the Internet is referred to as the World Wide Web (WWW). The WWW is comprised of an ever increasing number of web sites, which may contain one or more types of electronic data, generally referred to as content or web-based content. Web sites may be comprised of one or more web pages, for example, and a web page may additionally comprise a collection of numerous types and/or categories of content, including text, graphics, audio data, video data, and/or other data, for example, which may be referred to as multimedia content, for example. Internet-capable devices may be capable of accessing the content of a web site, and/or have the content displayed as one or more viewable objects on the display portion of a device, for example. The content associated with a particular web site may be located in one physical location, such as one or more electronic files arranged in a particular file structure on a web server, for example, or may be distributed between one or more physical locations and/or in differing file structures, for example. The location of a particular web page and/or web site may be identified by use of a Uniform Resource Locator (URL), which typically comprises a unique identifier capable of identifying the particular Internet address for a particular set of content. Additionally, web pages may link to one or more other web pages, web sites, and/or other types of electronic data by use of links and/or hypertext. Hypertext, in this context, may comprise one or more text symbols, such as words, but may have one or more embedded links, providing access to other web sites, additional web pages contained within the same web site, and/or other types of content, for example.

A user may utilize a device connected or coupled to the WWW to access content of a particular web site, by requesting that a server associated with the web site provide the device with data from the particular web site, for example. Due at least in part to the virtually limitless amount of content available to a user, and the commercial potential of Internet based commerce, for example, numerous attempts have been made by web site operators and others to provide customized web page content, based on factors including characteristics of the user accessing the web page, for example. However, while numerous methods exist for customizing content, a variety of trade-offs exist between the various approaches. A continual need exists, therefore, for a method and/or system for providing web-based content, where at least a portion of the content may be at least partially customized, for example.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a schematic diagram illustrating a system implementing an embodiment of the claimed subject matter;

FIG. 2 is a flowchart illustrating one method embodiment of the claimed subject matter;

FIG. 3 is a flowchart illustrating another method embodiment of the claimed subject matter; and

FIG. 4 is a schematic diagram illustrating another system implementing an embodiment of the claimed subject matter.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

The Internet, and, more specifically, the World Wide Web (WWW), has provided users with a virtually limitless source of information, available quickly and efficiently by use of a device capable of accessing the WWW. Devices capable of accessing the Internet may be referred to generally as Internet-capable devices. Devices such as these may vary, but typically are devices capable of executing one or more types of web browsers. Devices capable of executing one or more types of web browsers may include, for example, a personal computer (PC), a laptop computer, a personal digital assistant, and/or a wireless phone, for example, although, of course, the claimed subject matter is not limited in this respect, and numerous other types of devices may be configured to access at least a portion of the WWW. A web browser, in this context, typically comprises a set of executable code, typically in the form of software, configured to process electronic data, such as web page content, for example. Types of electronic data suitable for processing by a web browser may comply with a particular data protocol, for example, and the particular protocol or set of protocols may depend at least in part on the particular web browser, for example. One particular data protocol comprises HyperText Markup Language (HTML), although, again, the claimed subject matter is not limited to any particular data protocol, and may additionally include, for example, Extensible Markup Language (XML) or Java, as just a few examples. Additionally, data complying with a particular data protocol may be provided to a web browser for processing by use of a particular data transport protocol. Although numerous protocols exist, one particular protocol comprises Hyper Text Transfer Protocol (HTTP), for example, although numerous other protocols exist, including File Transfer Protocol (FTP), and Simple Mail Transfer Protocol (SMTP), for example. Additionally, while types and categories of web browsers may vary, two of the better known web browsers include the Netscape Navigator™ web browser and the Internet Explorer™ web browser, but it is noted that the claimed subject matter is not limited to a particular web browser.

A web site may be comprised of one or more web pages. A web page may comprise one or more data files complying with one or more data protocols, such as HTML, for example, with references to one or more other files, such as files comprising text, graphics, audio data, video data and/or other data, for example, which may be aggregated and/or published into a web page viewable by a user, such as on a display, for example. A particular web page located on the WWW may be identified by a conventional naming system, such as a uniform resource locator (URL). A URL is a particular naming convention that allows a web page and/or web site to be identified by a unique set of data. The URL may comprise a word or set of words, formatted into a standard URL, such as http://www.yourwebsite.com. This standard URL may additionally be associated with a unique numeric identifier, referred to as the Internet protocol (IP) address, sometimes referred to as the static IP address. The IP address, in at least one embodiment, is the internet address of a device, such as a web server, that contains at least a portion of the web page content, as well as the file path or paths where the content may be located on the web server, for example. Of course, devices may also employ dynamic IP addresses.

Electronic commerce has become increasing prevalent with advances in Internet-capable device technology, and with increases in the sophistication of web pages and internet security, for example. Generally speaking, the costs associated with operating a web site, such as a commercial web site, which may be referred to generally as a publisher web site, for example, have continually increased, and the more popular a web site is, generally, the more expensive it is to operate. As a result, many publisher web sites now sell advertising space, and, generally, there is strong competition between advertisers to place ads on these publisher web sites, due at least in part to the popularity of the web site, for example. Due at least in part to this competition, numerous differing methods of displaying and/or charging for advertising have emerged. A few of the more common WWW based advertising schemes include advertisers paying to display ads relating to their products and/or services on these popular, heavily accessed publisher web sites. However, it is noted that in this context, the term “ad” or “ads” refers generally to content of an informational nature that provides a notice or announcement to users in order to potentially trigger or produce a transaction, although, this is not limited to notices and/or announcements that offer goods and/or services for sale, but may comprise non-profit ads, public service announcements, or numerous other types and/or styles of ads and/or other notices. Regardless, these ads may be displayed as graphical and/or text based content and/or some other form of content, for example, at some location on a particular web site, such as a publisher's web site, and may be placed as blocks, banners, or tiles, for example.

Generally, the type, size and/or location of the ad may correspond with the cost of displaying the ad, and, in one particular advertising scheme, an advertiser may be charged based at least in part on the number of times the ad is displayed. This particular type of advertising scheme may be referred to as “cost-per-impression” advertising, for example, and may offer a relatively low cost per number of displays of a particular ad, for example. However, this particular type of scheme may provide no assurances to the advertiser that a particular ad is being displayed to the appropriate audience, and, therefore, may not be effective. As a result, alternative advertising schemes may be advantageous, such as where an advertiser pays a particular amount every time a user accesses the ad, for example, and, in this context, accessing the ad may refer generally to a user clicking a link, such as a hypertext or graphical link, which may be embedded in the ad, resulting in a web browser accessing web content located at a particular URL, for example, referred to generally as a “click-through”. Some of the more common methods of advertising that comply with this advertising scheme are called “pay-per-click”, “pay-for-performance”, and “cost-per-click”, for example.

As mentioned previously, there has been an increase in the number of advertisers utilizing the WWW, and, as a result, competition to place ads, and to have ads seen and/or accessed by users has additionally increased. Advertisers may compete for ad placement, ad size, ad frequency, and/or may use ad targeting, wherein ads may be displayed based at least in part on one or more characteristics, such as content of a particular web site visited by a user. For example, an advertiser may wish to have an ad placed on a publisher web site, and may wish to place an ad that relates to the content of the web site, in order to appeal to a user accessing the web site, for example. As one example, a user may visit a web site such as http://www.restaurant.com. An advertiser may wish to have an ad displayed for a product or service relating to restaurants, for example, so that a user may click on the ad and visit the advertiser's web site, for example. Additionally, a user may visit a publisher web site, such as a search engine web site, and may perform a search using particular search terms. A web page of “search results” may be displayed for the user, and an advertiser may wish to have an ad displayed on the search results web page, wherein the ad relates to a search term used by the user to perform a search, for example. As just an example, if a user performs a search for “restaurants” on a search engine web site, an advertiser with restaurant related products may desire to have an ad displayed as part of the search results web page, for example, resulting in an ad that may be more appealing, and may result in the user visiting the advertiser's web site, for example.

Continuing with this example, a search results web page may display search results that are not ads, and may additionally display one or more ads, such as ads based on one or more search terms, as explained previously. In this example, a user may click on an ad, or may click on a search result that is not an ad, and the likelihood that a user clicks on an ad may depend at least in part on how relevant the ad is to the users search terms, and may additionally depend at least in part on ad placement on a web page, and an advertiser may desire to place an ad at the most visible location on a web site, such as the top, so that a user may click on the advertiser's ad rather than a competitor's ad or on search results that are not ads, for example. In order to have ads displayed on a publisher web site, such as a search results web page, advertisers may specify one or more keywords associated with their ads, and these keywords may be used when a device operating a publisher web site is attempting to determine which ads to publish, for example. While competition may exist amongst advertisers, publishers additionally may be motivated to customize ads and/or ad placement for a particular user such that the user is more likely to click on one or more advertisements, resulting in higher click-through rates, resulting in more advertisers seeking to place ads on the publisher web site and, as a result, increased revenue for the web site publisher. However, click-through rates for ads published on a publisher web site such as a search results web site still may be relatively low, as compared to the click-through rates for search results that are not ads. Additionally, when ads are published on a web page, and the ads are determined based on the content of the web page, for example, the ads may not be necessarily relevant or accurate with respect to the interests of a user, resulting in the user not clicking on the ads. As a result, a continual need exists for methods and/or systems capable of providing web-based content, wherein the content may comprise ads, for example, and wherein the content may be at least partially customized, such as customized based on user data, for example.

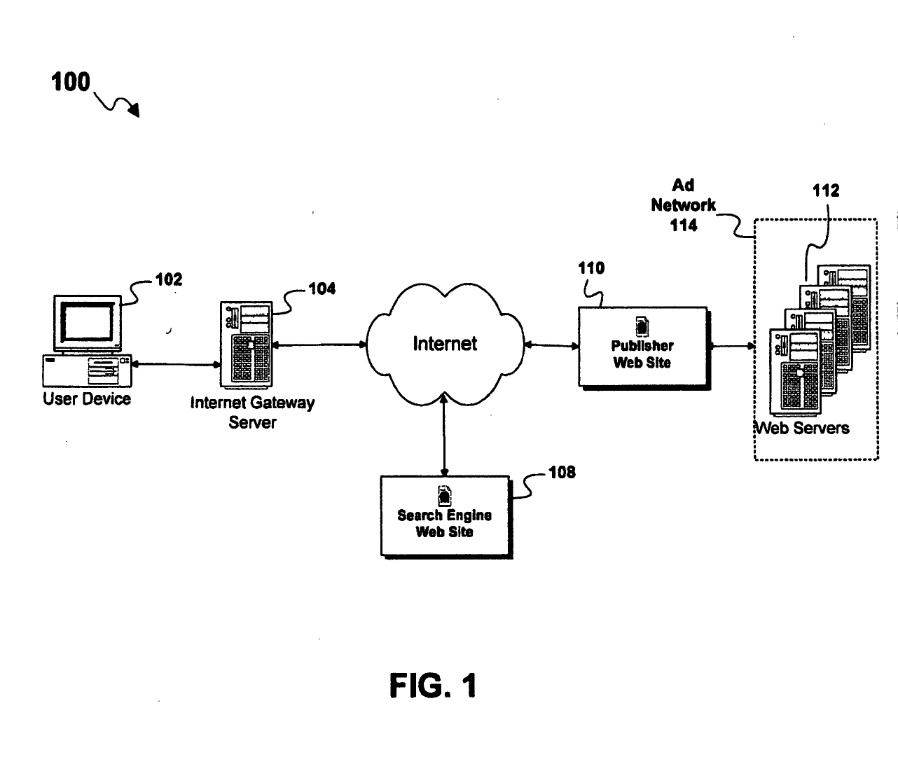

Referring now to FIG. 1, there is illustrated a schematic diagram of a system, which may implement at least one embodiment of the claimed subject matter. Illustrated in FIG. 1 is a system 100, which may be configured to allow a user to access one or more web pages on the WWW, for example. System embodiment 100 comprises a user device 102, illustrated herein as a personal computer, but it is noted that the claimed subject matter is not so limited, and any Internet capable device may be at least partially incorporated in system 100, as explained previously. In this embodiment, user device 102 is coupled to an Internet gateway server 104, and may be coupled by use of one or more well-known, or to be later developed, coupling devices, such as one or more network Interface cards, for example, and may additionally utilize one or more well-known, or to be later developed, communications media, such as coaxial cable, for example, although the claimed subject matter is not limited to any particular type or category of coupling device and/or communications media. Internet gateway server 104, in this embodiment, may provide Internet access for user device 102, and may comprise one or a plurality of servers, for example, or may comprise any device capable of providing at least partial Internet access for user device 102, for example. Internet gateway server 104 is illustrated as being coupled to the Internet, which, as explained previously, may comprise a multitude of coupled or interconnected devices, and may provide access between one or more devices, such as between user device 102 and one or more other devices, by use of an interface such as the WWW, for example.

Additionally shown coupled to the Internet is search engine web site 108. Search engine web site 108 may comprise software complying with one or more data protocols, such as HTML, for example, and may be embodied on one or more hardware devices, such as a server or other computing device, for example (not shown). Search engine web site 108 may comprise numerous components, and these numerous components may be aggregated on a web site, and reside on a single device or a plurality of devices, for example. Additionally shown coupled to the Internet is a publisher web site 110, which, as stated previously, may comprise any web site that may be accessed by a user, such as a commercial web site, which, in one embodiment, may comprise a web site offering goods and/or services for sale, or offering information relating to goods and/or services, for example. Again, similarly to search engine 108, publisher web site 110 may comprise software complying with one or more data protocols, such as HTML, for example, and may be embodied on one or more hardware devices, such as a server or other computing device, for example, (not shown) and additionally may comprise numerous components, and these numerous components may reside on a single device or a plurality of devices, for example. Publisher web site 110, in this embodiment, is illustrated as being coupled to ad network 114. This coupling may comprise a coupling of a web server (not shown), such as one that embodies at least a portion of a publisher web site, such as 110, to the ad network, for example.

An ad or advertiser network 114, in at least one embodiment, comprises multiple web servers 112, which may be configured to provide ads for multiple advertisers suitable for publishing on a web site, for example, and the multiple servers may contain one or more databases of ads or databases of ad identifiers, such as keywords and/or physical locations of ads, such as in the form of a URL, for example. Ad network 114 may comprise multiple servers, which may be interconnected or coupled, for example, or may comprise multiple servers not coupled, for example. Ad network may additionally comprise one or more additional components, such as load balancers and/or user interfaces, as just a few examples. Particular functions of an ad or advertiser network, such as ad network 114, will be explained in more detail hereinafter. Although system 100 is illustrated as having this particular structure, it is noted that the claimed subject matter is not so limited, and variations, deletions and/or modifications to the illustrated structure may be made and may still be in accordance with the claimed subject matter. Additionally, as stated previously, the Internet, and, more specifically, the WWW is comprised of numerous web sites, web servers, and/or other Internet-capable devices, and system 100 is not intended to represent the Internet or the WWW in its entirety, but, rather, is for illustrative purposes only.

In operation, a user may operate a device such as device 102 to access the WWW, for example, and may access a particular web site. For example, a user operating user device 102 may be provided with Internet access, such as through Internet gateway 104. The user may request access to a particular web site, such as publisher web site 110. The user may request to view the particular web site by entering the web site URL in web browsing software executing on user device 102, or by clicking on a link located on a web site, such as a link provided on search engine web site 108, for example, by use of a pointing device (not shown) coupled to user device 102. In one embodiment, a web server at least partially embodying search engine web site 108 and/or publisher web site 110 may set a cookie in user device 102, which, in this embodiment, comprises storing electronic data, such as the web site URL, and/or user identification data at a designated location on user device 102, and the storing may be at least partially performed by a web browser executing on user device 102, for example.

In one embodiment, a user may access a search engine, such as a search engine web site 108, for example. In this embodiment, the user may provide search engine web site 108 with one or more search terms, the search engine web site may receive the search terms, and one or more web servers executing the search may perform processing on the search terms, such as by searching other servers on the WWW for matches to the search terms, and/or generating other search results, for example. Search results may be provided to a user by publishing a search results web page, wherein at least a portion of the content comprises search results, for example. One or more results may comprise a link to a publisher web site, such as publisher web site 110, for example. After making a request to view the contents of a publisher web site, either by entering a URL, or by clicking a link, such as a link provided by a search engine, for example, user device 102 may request data, such as web site data from the publisher web site 110, for example. A request may comprise an HTTP request, for example, and the request may be received by a server at least partially embodying the publisher web site 110. In response to the request, the publisher web site server may provide electronic data, such as data in HTML format, to the user device 102. User device 102 may perform processing on the data, and may display the data as a web page in viewable form on a display device, for example.

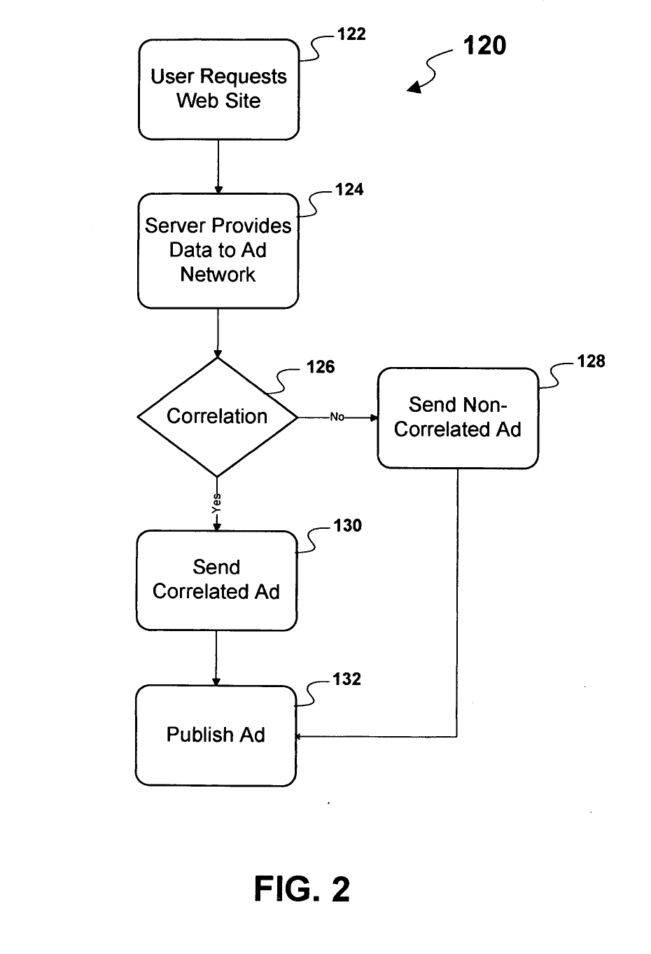

As stated previously, a publisher web site, such as publisher web site 110, may display one or more ads, and, in this context, the term “display” refers generally to a web browser resulting in display of web content on a display device, such as a monitor, for example. In this context, the term display is used interchangeably with the term publish. There may be limited space on a publisher web site to display or publish these ads, and, as explained previously, the publisher may be motivated to publish particular ads, such that a user may be more inclined to click on the particular ads, and visit a particular advertiser's web site, for example. The publisher may make a determination of which ad or ads to publish on a web site, as well as where or when, for example, by utilizing one or more types of data. In at least one embodiment, at least a portion of the data may relate to the user requesting the web site, for example. In this particular embodiment, a user may visit a first web site, such as search engine web site 108. A user may provide the search engine with one or more search terms, and the search engine may perform a search, as stated previously. The search engine may produce one or more search results, and at least one search result may comprise a link to a second web site, such as publisher web site 110. A user may click on the link, and thereby request a publisher web site 110. In this embodiment, when a user requests publisher web site 110, at least a portion of the data provided to the search engine, such as one or more search terms, may be provided to an ad network, such as ad network 114. Alternatively, a user may request access to a publisher web site by entering a URL in the user's web browser, for example. In this embodiment, user data may comprise the previous page visited, which may be referred to as a referring page, for example, and this data may be provided to ad network 114, for example. Ad network 114 may comprise multiple web servers 112, and at least one of the multiple web servers 112 may utilize the provided data to perform operations, such as correlation operations, and may, as a result of these operations, provide the publisher web site with an ad, for example. In at least one embodiment, the provided ad may be at least partially customized with respect to the user, such as by being generated based at least in part on user data, such as user provided search terms, and this may result in an ad that is more appealing to a user than an ad based only on the content of the publisher web site, as just as example. Customization of ads may be more fully understood when explained in more detail later. Additionally, correlation operations are explained in more detail later. Furthermore, user data may be obtained by use of numerous methods and/or from numerous sources, but one particular embodiment may be understood with reference to FIG. 2, below.

Referring now to FIG. 2, one embodiment of a method for providing web-based content is illustrated by a flowchart, although, of course, the claimed subject matter is not limited in scope in this respect. Thus, such an embodiment may be employed to at least partially provide web-based content, as described below. The flowchart illustrated in FIG. 2 may be used to substantially perform one or more operations of a system, such as system embodiment 100 of FIG. 1, for example, although the claimed subject matter is not limited in this respect, and the order in which the blocks are presented does not necessarily limit the claimed subject matter to any particular order. Likewise, intervening additional blocks not shown may be employed without departing from the scope of the claimed subject matter.

Flowchart 120 depicted in FIG. 2 may, in alternative embodiments, be implemented in software, hardware and/or firmware, and may comprise discrete and/or continual operations. In this embodiment, a user may request access to a web site, such as a particular web page of a publisher web site, as illustrated at block 122, and this request may comprise clicking a link provided by a search engine, or may comprise entering a URL, for example. As explained previously, a user may utilize one or more types of Internet capable devices, and may access the Internet by use of an Internet gateway, although this is not a requirement, of course. Additionally, requests and/or web-based content may comply with a particular data protocol or set of protocols, such as HTML, and/or data complying with one or more data protocols may be transported by use of one or more transport protocols, such as HTTP, as explained previously. In one embodiment, the web site may comprise web-based content at least partially stored in electronic form on a web site server, for example. In this embodiment, after a user requests a web site, the web site server at least partially embodying the web site may provide data to an ad network, as illustrated at block 124. Data may include, for example, URL data, and/or data relating to a search term utilized by a search engine, wherein the search engine produced particular search results, and wherein the search results at least partially influenced the user to make a request for the particular web page, for example.

Continuing with this example, prior to sending the data, in at least one embodiment, at least a portion of the data may be at least partially parsed. Parsed, in this context, refers to an operation whereby data, such as text based data, as only one example, is processed such that the resultant data may be interpreted, such as by dividing data into one or more terms or symbols recognizable by a computing device, for example. In this embodiment, the data may be at least partially parsed by the web site requested by the user, or by a server at least partially embodying the web site, for example. Alternatively, a web browser, such as a web browser providing Internet access to a user may perform parsing. In yet another alternative embodiment, the ad network, or one or more components of the ad network, may at least partially parse the provided data, such as by providing the data to a parsing engine, for example. At block 126, a decision may be made as to the occurrence of a correlation between the at least partially parsed data and one or more other sets of data, which may comprise ad data, for example, such as ad keywords. Types and methods for determining correlation may vary, but in at least one embodiment, correlation may comprise performing a query of a database, such as a database comprising ads, for example, or may comprise a keyword search of a database such as a database comprising ad keywords. If there is no correlation, for example, such as where no set of data is found that relates to the parsed data, a non-correlated ad may be sent to the web site at block 128. However, if there is a correlation, an ad based at least in part on the correlation and/or the parsed data may be sent to the web site, such as illustrated at block 130. At block 132, the ad sent may be at least partially published, such as on a user device, in the form of web-based content as part of a web page, such as part of publisher web site 110, for example.

In this embodiment, as illustrated at block 122, a user may request access to a web site by use of a device, such as user device 102 of FIG. 1, for example. This may comprise a user entering a URL of a web site, for example, or may comprise a user clicking a link, such as a graphical link or hyperlink provided by a first web site, such as a search engine web site, for example, although other methods exist, and the claimed subject matter is not so limited. In one embodiment, a user may visit a first web site, and the first web site may be associated with a particular URL, for example. A link may be provided for display on a user device, and may be generated by a first web site, such as a search engine web site as a search result, and, in this particular embodiment, a user may first perform a search, and may subsequently be provided with a link, and may request to view a second web site by clicking on this link with a pointing device coupled to user device 102, for example. In one embodiment, the second web site may comprise a web site associated with a differing URL than the URL associated with the first web site, as just an example, and may comprise a publisher web site, for example.

In this embodiment, as illustrated at block 124, a server may provide data to an ad network. In one embodiment, this may be performed by the web server at least partially embodying a web site, such as a search engine web site, although, again, this is not a requirement. In at least one embodiment, the data may comprise electronic data, and may comprise data provided by a user, such as a URL, a search term, or a cookie, for example. For example, a user may enter a URL of a web site the user wishes to view. The URL, or a portion thereof, may be provided to an ad network. Alternatively, if a user performs a search, such as by visiting a first web site, such as a search engine web site, the search term or terms used in the search that resulted in the display and/or subsequent clicking of a link directing the user to a second web site, such as a publisher web site, may be provided to an ad network. For example, for purposes of illustration, a user may enter the URL http://www.madelinesrestaurant.com, or a portion thereof. A request to view the web site may be sent to the web server associated with the contents of that particular web site, for example, and the URL, or alternatively, the IP address, or a portion thereof, may be provided to the ad network, and may be provided by the server, for example. Alternatively, a user may first access a first web site, such as a search engine web site, for example, http://www.yoursearchengine.com, which may be associated with a particular URL. A user, in this embodiment, may provide the term “restaurant” as a search term to the search engine web site. A link may be generated as a search result, and the link may direct the user to a second web site, such as a publisher web site, wherein the web site is being operated by a particular web server, for example, and may be associated with a differing URL than the first web site, for example. In this particular embodiment, the search engine web site may be referred to as a “referring page”. A user may click on the provided link, and at least a portion of the data identifying the referring page, as well as a portion of the search data, such as a search term, may be provided to the web server. In this example, the above noted search engine may provide the following URL, or a portion thereof, to an ad network: http://www.yoursearchengine.com/search?query=restaurant. Of course, this is just an example, and the claimed subject matter is not so limited.

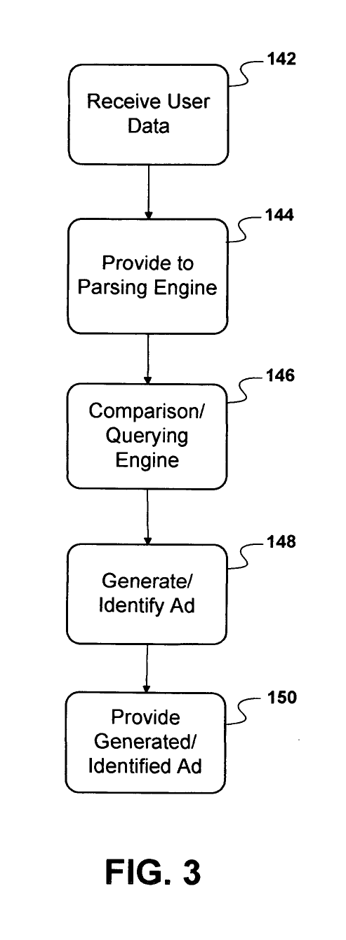

In this embodiment, as illustrated at block 126, the web server may at least partially parse the provided data, which may comprise, for example, removing words, letters and/or symbols that may not assist in identifying one or more user traits, for example. Continuing with the above example, if user data comprises the URL http://www.yoursearchengine.com/query?=restaurant, or a portion thereof, the ad network may parse the URL into usable terms, such as by removing the “http://”, “search?query=” and/or “.com”, and may parse the remaining data into recognizable terms, such as “yoursearchengine” and “restaurant”, for example, although it is noted that the claimed subject matter is not limited to parsing, or to any particular method of parsing. At least one embodiment of parsing may be better understood when explained with reference to FIG. 3, later.

Referring again to FIG. 2, in this embodiment, at block 126, a determination may be made as to whether or not there is a correlation between one or more parsed terms and one or more sets of criteria. Methods of determining correlation may vary, and the claimed subject matter is not so limited, but in one particular embodiment, one or more parsed terms may be used to make a query, such as to a database. In this embodiment, a query may be made by requesting that the database return data contained within the database that correlates with one or more query terms, such as by providing the database with a query term, and requesting that any results correlating with the query term be returned. Continuing with the above example, the term “restaurant” may be provided to a database. The database may perform a query, and the database may perform a keyword search of ads contained in the database. One or more ads may contain the word “restaurant” or a variation thereof, and the query results may identify the one or more ads. Alternatively, one or more ads may have identifier words, such as keywords. These keywords may be specified by an advertiser when providing a database with an ad. For example, an advertiser may sell restaurant related products. The advertiser may provide the database with a keyword, such as restaurant, and that keyword may be used to identify the advertiser's ad. A query may be performed on keywords, and a query result may comprise identification of any ads wherein an advertiser has specified the keyword “restaurant”, for example. The query result may comprise one or more ads, such as one or more text ads, and/or other types of ads, and/or one or more identifiers for ads, such as a location on a server, such as a URL, for example. Additionally, a query may return no results, and, in this case, this may comprise non-correlation. In this particular embodiment, if a determination is made that there is no correlation, for example, such as by a query not returning results, for example, a non-correlating ad may be identified for display in a web site, and the ad, a portion thereof, or identifying information for the ad may be sent to the web site server, for example. Alternatively, no ad may be sent, a predetermined default ad may be sent, or a random ad may be sent, for example, as explained in more detail with reference to block 128, below.

In this embodiment, at block 130, if at block 126 a determination is made that a correlation exists, such as between one or more query terms and an ad available to the ad network, for example, the ad may be at least partially provided to a web server, such as a web server at least partially embodying a web site requested by a user, or, alternatively, one or more identifying terms may be provided to a web server, and a web server may retrieve the ad by use of the identifying information, for example. In this embodiment, the ad or ads may be retrieved from one or more locations, such as an ad network, and may be published on a second web site, such as illustrated by block 132, such as on or at a publisher web site as requested by a user at block 122, for example. In at least one embodiment, the ad or ads may be more appealing to a user than ads generated based solely on the content of the publisher web site, for example, because the ad or ads are identified and/or generated based at least in part on data at least partially provided by a user in at least one embodiment, for example, a search term or terms provided by a user to a search engine web site. These ads may be more customized and/or more appealing, for example, because, generally, use of the content of the publisher web site to generate ads may not result in the generation of ads that are based on user data, and as a result may not be appealing to a user. Of course, this is just one embodiment, and the claimed subject matter is not limited in this respect.

In this embodiment, at block 128, if at block 126 a determination is made that no correlation exists, such as by not meeting a particular criteria based on a query and/or search, for example, a non-correlating ad may be provided to a second web site, such as by being provided to a server at least partially embodying a web site, for example. In one embodiment, a set of non-correlating ads may exist that are displayed if no correlation exists as determined by block 126, for example, and may comprise one or more ads, or other information that is not customized based at least in part on correlated data, for example. An ad that is not a correlated ad may, however, coincidently correlate, such as by relating to one or more query terms, but wherein the query did not identify the ad because ad keywords varied from the query terms, for example. In one embodiment, no ad may be sent, and no ad may subsequently be published on a web site, for example. Alternatively, a random or pseudo-random ad may be selected and displayed, for example. In this embodiment, if an ad is displayed, the ad may be retrieved from one or more locations, such as from an ad network, and may be published as part of a web site, such as illustrated at block 132, such as on or at a publisher web site as requested by a user at block 122, for example.

Referring now to FIG. 3, one embodiment of a method for providing web-based content is illustrated by a flowchart, although, of course, again, the claimed subject matter is not limited in scope in this respect. Thus, such an embodiment may be employed to at least partially provide web-based content, as described below. The flowchart illustrated in FIG. 3 may be used to substantially perform one or more operations of a system, such as system embodiment 100 of FIG. 1, for example, although the claimed subject matter is not limited in this respect, and the order in which the blocks are presented does not necessarily limit the claimed subject matter to any particular order. Likewise, intervening additional blocks not shown may be employed without departing from the scope of the claimed subject matter.

Flowchart 140 depicted in FIG. 3 may, in alternative embodiments, be implemented in software, hardware and/or firmware, and may comprise discrete and/or continual operations. In this embodiment, user data may be received, as illustrated at block 142. This user data may comprise, for example, URL data and/or referring page data, as explained previously, and may be received by a device, such as a server of an ad network, for example, as explained in more detail below. At block 144, if the user data is not parsed prior to being received, at least a portion of the data may be provided to a parsing engine, which, in at least one embodiment, may comprise a software based engine executing on a hardware device, such as a server. The parsing engine may be capable of performing one or more parsing operations, such as those explained previously. At block 146, one or more querying and/or comparison operations may be performed by a comparison/querying engine, and may be performed on the parsed data or a portion thereof, for example. At block 148, results of the query and/or comparison may be determined, and one or more ads may be generated and/or identified. At block 150, the one or more generated and/or identified ads may be provided, such as provided to a web server for publication on a web site, such as a publisher web site, for example.

In one embodiment, as illustrated at block 142, for example, user data may be received, and may be received by an ad network, such as by one or more servers 112 of an ad network 114 of FIG. 1, for example. The user data may be electronic data comprising a URL and/or IP address or a portion thereof, and/or may contain data at least partially identifying a referring page, and/or may include search terms entered by a user that provided the user with a referral page, for example, as explained previously. The data may be received by a web server, for example, and may be parsed or partially parsed prior to being received, and may be parsed by a user's web browser, or by a web site visited by the user, or server at least partially embodying the web site, for example. If the data is not fully parsed when received, for example, the data may be provided to a parsing engine, which, as stated previously, may comprise a software-based parsing engine, and may be located on one or more servers 112 of ad network 114, for example. The parsing engine may be capable of parsing one or more text based terms of a URL, for example, by removing one or more non-specific or non-identifying terms, as explained previously. Of course, other data other than text data may also be parsed, depending on the particular embodiment.

In this embodiment, at block 146, for example, one or more parsed terms may be provided to a comparison/querying engine. This engine may be capable of performing one or more comparison and/or querying operations of one or more parsed terms, and may be capable of accessing one or more databases as part of the one or more operations. For example, the engine may receive one or more parsed terms, and may perform comparison operations in the following manner, for example: one or more parsed terms may be used to perform a search of one or more databases, wherein the search comprises a search for a match or partial match of the one or more parsed terms. For example, using the previous example, a comparison function on the term “restaurant” may return matches for terms “restaurant”, “restaurants” and/or “restaurateurs” as just an example. Alternatively, a query operation may be made on a parsed term, such as restaurant, as in the following manner, for example: a querying engine may query, or ask, one or more databases what matches the database(s) have for a term “restaurant”. The database(s) may have one or more results designated as a match to that particular term, such as by a keyword and/or other database parameter specified by an advertiser and/or otherwise specified, and may return one or more of the results as an answer to the query. In this embodiment, the result may not be a literal match of the term, but may be designated as a match by use of the aforementioned keyword, for example. In yet another alternative embodiment, comparison and querying operations may be performed in conjunction, and results of these operations may be returned, for example. In one embodiment, advertisers requesting the publication of ads may be capable of assigning particular keywords for their ads, and the keywords may be words associated with their ads, and/or may comprise keywords that the advertiser believes would be used by a user who might be likely to click on an advertisers' ad, for example.

In this embodiment, as illustrated at block 148, for example, one or more ads may be identified and/or generated, and may be identified and/or generated based on the operations performed as illustrated at block 146, for example. One or more ads may be identified, in one embodiment, based on the results obtained, as illustrated, at block 146, for example, and these one or more ads identified may be retrieved and provided to a web server for publication on a web site, for example. The one or more ads, or identifying information regarding the one or more ads, may be stored on one or more ad servers 112, for example, and may be provided to a web server for publication on a web site, for example. Alternatively, one or more ads may be generated based at least in part on the results of operations, such as those illustrated by block 146, for example. In this embodiment, operations illustrated by block 146 may return results, such as parameters within which to generate an ad. For example, a parsed term “restaurant” may be used to perform one or more comparison and/or querying operations, and the results may identify parameters, such as which ad to generate, the contents of the ad, and/or terms to have in an ad template, for example, such as parameters instructing an ad generating/retrieving engine to generate a text based ad with the term “restaurant” in it, based on an ad template wherein keywords are omitted. For example, an ad template may comprise the text, “Visit [web site] for deals on [product]”, where the bracketed portions of the ad are replaced with a web site and product for a particular advertiser, and one or more embedded links are associated with the web site and/or product of a particular advertiser, for example, resulting in a user being capable of clicking a portion of the advertisement, and subsequently being provided access to the advertiser's web site, for example. Of course, ads having other forms may be generated and/or identified, and by alternative techniques. The claimed subject matter is intended to cover such alternatives.

In this embodiment, at block 150, the one or more generated and/or identified ads, which may comprise text based ads, for example, may be provided for publication, and may be provided to a web server which contains web site content for publication on a publisher web site, for example. The identification of an ad may comprise providing the web server with a URL of an ad or where in a particular file structure of a device the ad may be obtained, for example. Alternatively, the ad may be provided, such as in a particular data format, to the web server, such as HTML data comprising an ad, for example. In addition, one or more instructions concerning the ad placement, duration, and/or other information may be provided, such as by a web server of an ad network, and this information may be based on instructions provided by an advertiser, such as placement of the ad at the top of a web site, or placing the ad between particular calendar days, for example. As described previously, the ad published on the publisher web site may be more appealing and/or more customized with respect to a user, because, for example, the ad may be based at least in part on user data, such as one or more search terms provided by a user, in at least one embodiment. Because the ad is based at least in part on user data, in at least one embodiment, the ad may be more appealing and or customized with respect to a user than an ad based on publisher web site content, which would, generally speaking, be the same content for any number of users, for example. Use of user data to at least partially generate ads may result, for example, in a higher click-through rate for ads published on a publisher web site, due to the increased appeal and/or customization of ads with respect to a user, for example.

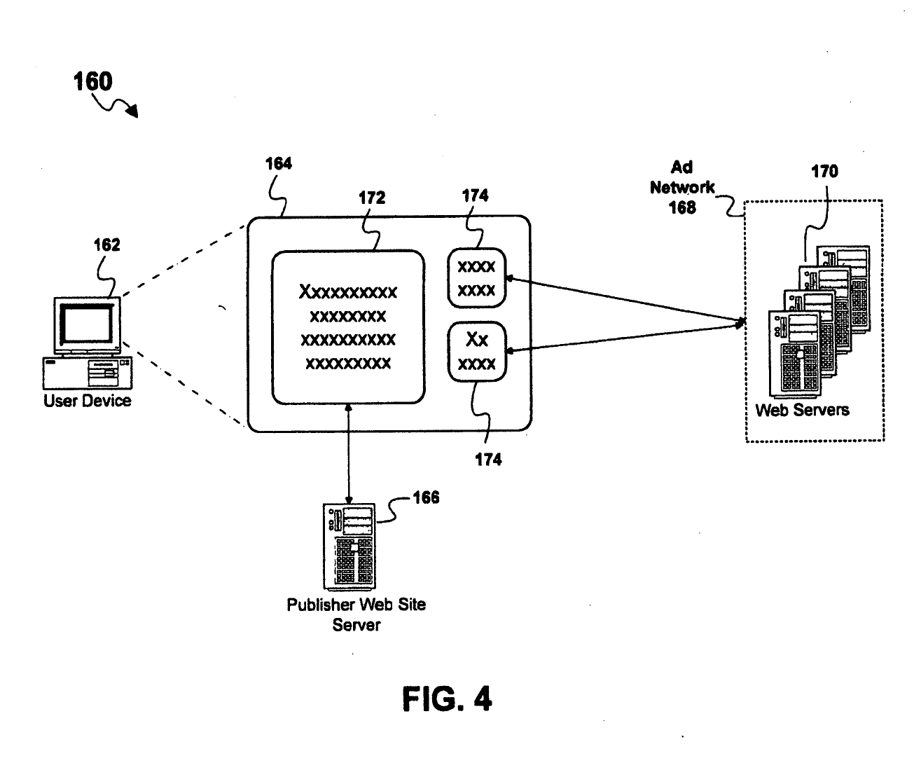

Referring now to FIG. 4, there is illustrated a system 160, and a web page 164, resulting from one or more interactions between one or more components of system 160, for example. Of course, this is simply one sample embodiment and the claimed subject matter is not limited in scope to this particular sample. However, in this embodiment, system 160 comprises a user device 162, and may be similar to user device 102 of FIG. 1, for example. User device 162 may be capable of displaying a web page 164. Web page 164, which may comprise an aggregation of one or more files, for example, and may comply with one or more data protocols, for example, may be comprised of content 172 and content 174. Web page 164 may be generated by one or more devices, such as publisher web site server 166 and/or ad network 168, for example. The particular data contained in content 172 and/or 174 may be generated based at least in part on one or more inputs of a user operated device 162, for example, such as a URL provided so that a user may view the web site or search terms provided to a search engine, as explained previously. In response to this user input, one or more devices of ad network 168, such as a web server 170, may generate content 174, which may comprise one or more ads, such as text based ads, for example, wherein at least a portion of the ad comprises text and/or hypertext. In at least one embodiment, therefore, content 174 comprises one or more text based ads, wherein the text based ads are formed based at least in part on user data, for example. Additionally, content 172 may be generated by publisher web site server 166, for example, and may be based at least in part on user data, such as the URL entered into the user device 162, for example. However, content 172 may not be customized in the same manner as content 174, for example, and may comprise default content that is displayed when a user visits a particular URL, for example. Of course, this is just one embodiment of a web page, and the claimed subject matter is not so limited.

It is, of course, now appreciated, based at least in part on the foregoing disclosure, that software and/or hardware may be produced capable of performing one or more of the above-described operations. It will, of course, also be understood that, although particular embodiments have just been described, the claimed subject matter is not limited in scope to a particular embodiment or implementation. For example, one embodiment may be in hardware, such as implemented to operate on a device or combination of devices, as previously described, for example, whereas another embodiment may be in software. Likewise, an embodiment may be implemented in firmware, or as any combination of hardware, software, and/or firmware, for example. Likewise, although the claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with the claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

1. A method for providing web page content, comprising:
receiving user data;
providing at least a portion of said user data to an ad network;
receiving electronic data from said ad network; and
publishing web page content on a web page, wherein said web page content is based at least in part on said electronic data.

2. The method of claim 1, wherein said publishing comprises:
generating web page content by use of said electronic data.

3. The method of claim 2, wherein said generated web page content comprises generating an ad.

4. The method of claim 3, wherein said ad comprises a text-based ad.

5. The method of claim 1, wherein said receiving user data further comprises being provided with electronic data, wherein said electronic data comprises data provided by a user.

6. The method of claim 5, wherein said data provided by a user comprises one or more search terms.

7. The method of claim 5, wherein said data provided by a user comprises at least a portion of a Uniform Resource Locator (URL), wherein said URL identifies a web page requested by a user.

8. The method of claim 7, wherein said web page requested by a user comprises a first web page.

9. The method of claim 8, wherein said publishing web page content comprises publishing web page content on a second web page.

10. The method of claim 9, wherein said first and said second web page are associated with differing URLs

11. The method of claim 8, wherein said first web page comprises a search engine web page.

12. The method of claim 9, wherein said second web page comprises a publisher web page.

13. The method of claim 1, wherein said ad network is capable of parsing at least a portion of said user data.

14. The method of claim 13, wherein said receiving electronic data from said ad network comprises:
determining a correlation for at least a portion of the parsed data, wherein said correlation may be based, at least in part, on one or more database queries.

15. The method of claim 14, wherein said receiving electronic data further comprises being provided with correlation results, wherein said correlation results are determined by said ad network.

16. The method of claim 15, wherein said correlation results comprise data identifying an ad.

17. The method of claim 16, wherein said data identifying an ad comprises ad content.

18. A method for providing web page content, comprising:
receiving user data at a first web page;
parsing at least a portion of the user data;
querying one or more databases with at least a portion of the parsed data; and
providing one or more sets of electronic data, based at least in part on said query to a second web page.

19. The method of claim 18, wherein said receiving user data comprises receiving at least one query term;
wherein said querying comprises querying by use of said at least one query term; and
wherein providing one or more sets of electronic data comprises providing a generated ad in the form of electronic data to said second web page.

20. The method of claim 18, wherein said user data is received from a publisher web site that includes said first web page.

21. The method of claim 18, wherein said user data comprises one or more search terms.

22. The method of claim 18, wherein said one or more sets of electronic data comprise one or more ads.

23. The method of claim 22, wherein said one or more ads comprise one or more text-based ads.

24. The method of claim 18, wherein said data received comprises at least a portion of a Uniform Resource Locator (URL), wherein said URL identifies a web page requested by a user.

25. The method of claim 18, wherein said querying comprises determining a correlation between said received data and data stored in one or more databases.

26. A method of publishing a web site, comprising:
receiving user data;
providing at least a portion of said user data to a web server;
receiving electronic data from said web server; and
publishing an ad on said web site, said ad being based at least in part on said electronic data.

27. The method of claim 26, wherein said publishing comprises:
generating said ad by use of said electronic data.

28. The method of claim 26, wherein said ad comprises a text-based ad.

29. The method of claim 26, wherein said receiving user data further comprises being provided with electronic data, wherein said electronic data comprises data provided by a user.

30. The method of claim 29, wherein said data provided by a user comprises at least a portion of a Uniform Resource Locator (URL), wherein said URL identifies a user requested web site.

31. The method of claim 30, wherein said user requested web site comprises a first web site.

32. The method of claim 31, wherein said first web site comprises a search engine web site.

33. The method of claim 31, wherein said web site publishing said ad comprises a second web site.

34. The method of claim 33, wherein said second web site includes ads from multiple advertisers.

35. The method of claim 26, wherein said web server is further configured to, in operation:
at least partially parse said user data; and
determine a correlation for at least a portion of the parsed data, wherein said correlation may be based, at least in part, on one or more database queries.

36. A system, comprising:
a web server;
a web site, wherein said web site is embodied at least partially on said web server, and wherein said web site is capable of being accessed by a user;
an ad network, said ad network comprising multiple web servers;
said web site server being capable of sending electronic data to one or more web servers of said ad network, wherein said electronic data is based at least in part on data provided by said user, and wherein said one or more web servers of said ad network being capable of returning electronic data to said web site server, wherein said returned electronic data is based at least in part on said data provided by said user.

37. The system of claim 36, wherein said one or more web servers of said ad network are capable of returning electronic data in the form of one or more ads.

38. The system of claim 36, wherein said web site server is capable of generating an ad by use of said returned electronic data at least in part.

39. The system of claim 36, wherein said ad network is further configured to, in operation:
parse at least a portion of the sent electronic data;
query one or more databases with at least a portion of the parsed data; and
provide said returning electronic data based at least in part on said query.

40. A web page, comprising:
web page content, said web page content further comprising one or more ads, wherein said one or more ads are provided by an ad network, wherein said one or more ads are based at least in part on a Uniform Resource Locator (URL) associated with the web page.

41. The web page of claim 40, wherein at least one of said one or more ads comprise one or more text-based ads.
